(19) United States
(12) Patent Application Publication
(10) Pub. No.: US 2007/0022645 A1
(43) Pub. Date: Feb. 1, 2007

(54) Magnetic display holder

(76) Inventor: Luna H. Villarin, Lakewood, CA (US)

Correspondence Address: MICHAEL A. SHIPPEY, PH. D., 4848 LAKEVIEW AVENUE, SUITE B, YORBA LINDA, CA, 92886, US

(21) Appl. No.: 11/193,902

(22) Filed: Jul. 29, 2005

(51) Int. Cl. G09F 7/04

(52) U.S. Cl. 40/600

(57) ABSTRACT

The present invention serves as a display device that is set on the top edge of magnet-attracting furniture or appliances, and that utilizes a plurality of sheet or strip magnets placed vertically and horizontally at an approximate 90 degree angle on the interior of the device base to secure said display device onto the top edge of the furniture or appliance. Said devices include display components that are ornamental or functional, interchangeable, animated, and/or user-programmable.

### BACKGROUND OF THE INVENTION

The present invention relates to the field of magnets, and more particularly to a three-dimensional display having sheet magnets on two surfaces for attachment to a metal shelf or refrigerator and having on the exterior surface a combined ornamental display and functional component that may be changeable, providing practical assistance by means of a hook, LCD screen, clock, thermometer, barometer, data, or audio device.

### DESCRIPTION OF RELATED ART

Prior art has developed various embodiments of decorative attachable devices used for both practical and ornamental purposes. One form is to connect the decorative and functional components to a one-sided magnetic strip or sheet magnet. Sheet magnets are commonly used to display ornamental designs and to hold paper notes, pictures, and photographs. These magnets are utilized to affix said devices to the side-wall of a refrigerator, file cabinet, medicine cabinet, or other similar metal appliance, board, cabinet, or vertical surface. In addition to being ornamental, such devices have functioned to hold items in a prominent location, such as calendars and event reminders, photographs of family and friends, recipes and diets, and the like.

A major disadvantage of the prior art using sheet or strip magnets is the inability to remain securely attached to the vertical surface. Such devices are not useful to hold objects that weigh any more than a few ounces, such as towels, aprons, notepads, calendars, and the like because the weight of the object causes the device to slide downward or to fall off the metal surface completely, the magnetic force being opposed by the weight of the object. A similar result occurs when the vertical surface experiences a vibration, like that which occurs when a refrigerator or cabinet door is opened and closed. The magnet will be in motion with the door, and the force of the motion will oppose the magnetic force, causing it to lessen and in turn cause the fixture to slide downward or fall off altogether. If attached on the front of a cabinet or refrigerator door, the force required for opening the door can create enough of a forward motion that the magnetic force will not be sufficient to oppose the motion force, causing the magnet to separate from the door and be flung off. To ensure secure attachment, prior art magnetic display units have had to use magnetic panels of significant size or of materials that are capable of holding a greater magnetic charge, therefore costing more or obscuring more of the vertical surface.

A further disadvantage of prior art that uses sheet or strip magnets is that the heat emitted by the appliance to which the magnet is attached will over time reduce and eventually eliminate the magnetic charge. This reduction in magnetism occurs more rapidly if the magnets are also subject to opposing forces, such as weight, gravity, and motion. Thus, magnetic display devices that do not counteract said opposing forces will eventually lose their magnetism.

As another means of ensuring secure attachment, other embodiments of similar inventions utilize a polymer glue strip or other self-holding adhesive on one side of the decoration to mount permanently the invention to the desired surface. Once they have been adhered to a surface, these displays usually cannot be removed without leaving a faded or marred area and/or adhesive residue. Moreover, they cannot be moved and reused easily unless new glue or adhesive can be applied.

It has been known to construct display devices that use sheet magnets in planar form having an exterior surface of the sheet magnet for connection with the metal surface and having the opposing surface displaying some ornamentation. A further disadvantage of this prior art is that the ornamental attachments cannot be altered, so that the overall appearance and application of the invention is not changeable. While some devices in the form of frames allow for photographs or pictures to be inserted into them, the frame of the device still remains the same.

Prior to the present invention, it has not been known to secure a three-dimensional magnetic display device to two surfaces, namely a horizontal and vertical surface, of a metal cabinet, shelf, or refrigerator.

### BRIEF SUMMARY OF THE INVENTION

The basic embodiment of the present invention utilizes a plurality of strips of strong magnetic material in horizontal and vertical alignment on the under surface of a three-dimensional display device, said magnetic strips being used to attach the display device to the upper horizontal surface and the front or side vertical surface of a metal shelf, file cabinet, refrigerator, or other furniture, cabinet, or appliance. The display device is capable of having changeable ornamental figures and changeable functional devices embedded or attached to its upper surface. A plurality of display devices can be used together with or without interconnecting ornamentation or functional components.

It is an object of the present invention to provide a reusable, interchangeable decorative and functional display device for use on magnet-attracting metal furniture, cabinets, and appliances.

It is an object of the present invention to provide for attachment of said display device using magnetic strips on two different planar surfaces to secure it against movement of the surfaces to which the device is attached such that the forces inherent in said movement will not be sufficiently opposing as to overcome the magnetic force and cause the display device to separate from the magnet-attracting surface.

It is an object of the present invention to utilize the weight of the display device in conjunction with the magnetic charge to attach said device on a movable magnet-attracting surface sufficiently as to overcome the forces created by movement and keep said magnetic display device in place on the magnet-attracting surface.

A further object of the present invention is to exhibit a plurality of user-defined informative devices that can indicate time, temperature, or moving characters and letters across an LCD screen powered by a computer chip and/or battery, that can display a user-programmable message, or that can play music.

One embodiment of the present invention is to provide a frame and photograph receiving compartment, and another embodiment provides for one or more hooks from which items, such as keys, glasses, hand towels, and potholders, can be hung.

A primary objective of this invention is to decrease the cost of the magnetic strips and materials required in said display device and to increase the useful life of said magnetic display devices by utilizing the forces of gravity and weight in conjunction with the magnetic force to secure the device to the magnet-attracting surface.

### BRIEF DESCRIPTION OF THE DRAWINGS

For a better understanding of the present invention, reference is to be made to the accompanying drawings. It is to be understood that the present invention is not limited to the precise arrangement shown in the drawings.

FIG. 1 is a perspective view of a first embodiment of the present invention from the front of the display device, showing display screen.

FIG. 2 is a perspective view of a first embodiment of the present invention from the front of the display device, without display screen.

FIG. 3 is a perspective view of a second embodiment of the present invention from the front of the display device, showing display screen

FIG. 4 is a perspective view of second embodiment of the present invention from the front of the display device, without display screen.

FIG. 5 is a perspective view of a third embodiment of the present invention from the front of the display device, showing dual display devices with display screens.

FIG. 6 is a perspective view of a third embodiment of the present invention from the front of the display device, showing dual display devices without display screens.

FIG. 7 is a perspective view of a fourth embodiment of the present invention from the front of the display device, illustrating an ornamental display in combination with a display screen.

FIG. 8A is a perspective view of the first embodiment of the present invention showing attachment of the magnets.

FIG. 8B is a back view of the present invention, showing the magnet attachment.

FIG. 8C is a bottom view of the present invention, showing the magnet attachment.

FIG. 9A is a perspective view of the second embodiment of the present invention showing attachment of the magnets.

FIG. 9B is a back view of the present invention, showing the magnet attachment.

FIG. 9C is a bottom view of the present invention, showing the magnet attachment.

FIG. 10A is a perspective view of the third embodiment of the present invention showing attachment of the magnets.

FIG. 10B is a back view of the present invention, showing the magnet attachment.

FIG. 10C is a bottom view of the present invention, showing the magnet attachment. FIGS. 11-17 show examples of displays available for the present invention.

FIG. 11 is a view of an advertising display for the present invention.

FIG. 12 is a view of an advertising display for the present invention.

FIG. 13 is a view of a calendar display for the present invention.

FIG. 14 is a view of a reminder display for the present invention.

FIG. 15 is a view of another reminder display for the present invention.

FIG. 16 is a view of a shopping list display for the present invention.

FIG. 17 is a view of a book display for the present invention.

### DETAILED DESCRIPTION OF THE INVENTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as representative basis for teaching one skilled in the art to employ the present invention in virtually any appropriately detailed system, structure or manner.

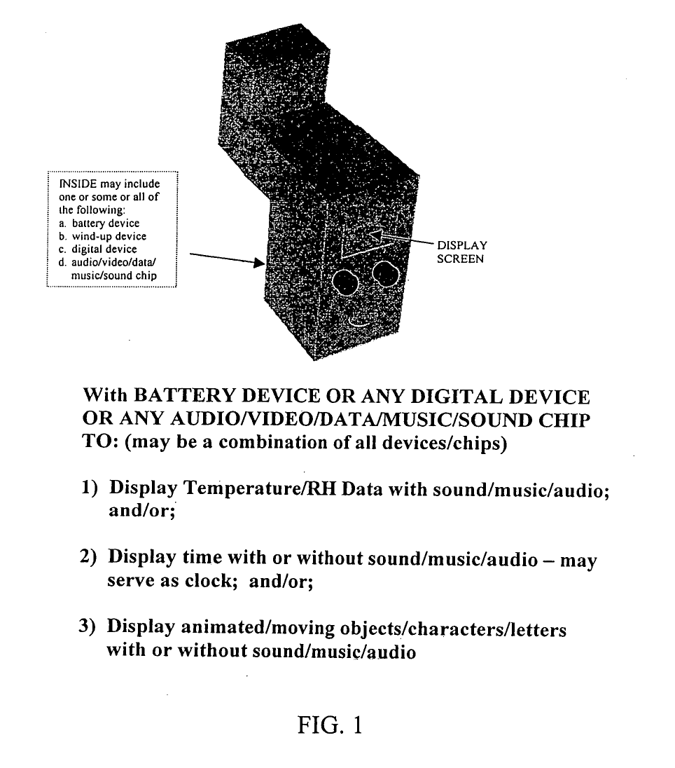

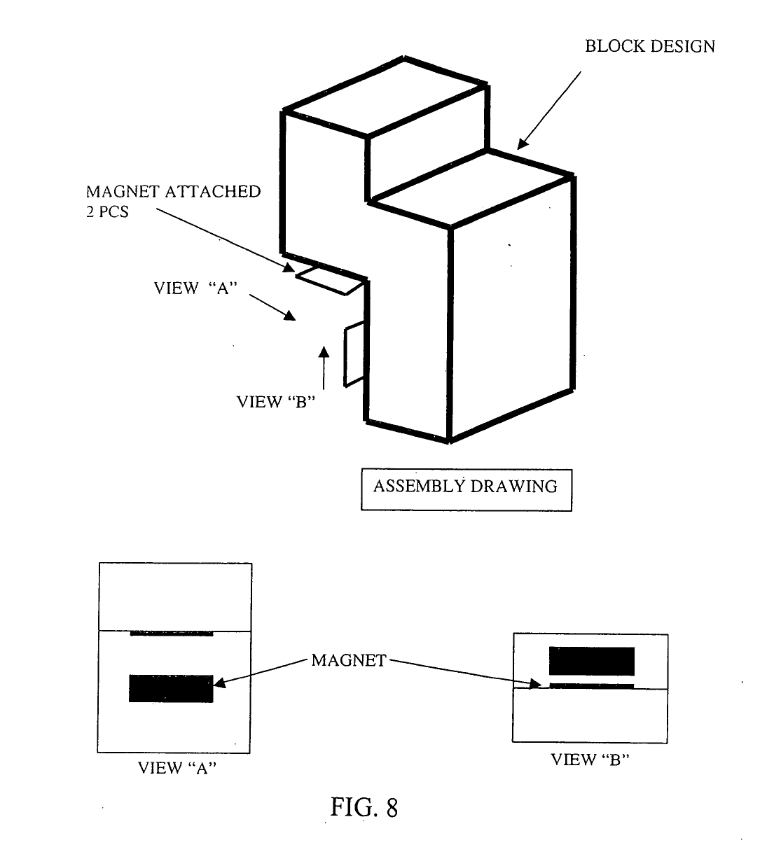

Referring particularly to the drawings, there is shown in FIG. 1 a first embodiment of the present invention 10, comprising a base 12 that is rigid and weighted from which two projections extend, one at a ninety degree angle upward 15 and one at a ninety degree angle downward 17. The base and the downward projection include sheet magnets attached to the interior surfaces, which are not visible from this view, so that, when the invention is placed against a magnet-attracting surface, the magnetic force will securely attach it to the magnet-attracting surface. Said magnets are shown in FIG. 8.

When in use, the exterior surface 18 of the base of the present invention is planar with the horizontal surface of the magnet-attracting surface, and it may have figurines, scenes, photograph frames or holders, and other ornamental displays attached to it. The exterior surface of the projection 19 may display further ornamentation, may be used to insert one of a plurality of battery operated or digital chip devices, or may be used for a functional hook, clip, or similar mechanism for hanging keys, aprons, towels and other such items. In this drawing, a digital screen 20 for the display of time, animated or moving words or figures, temperature, and other data at the preference of the user, and also having control knobs 22 and a speaker 24 for audio presentations is represented for purposes of illustration.

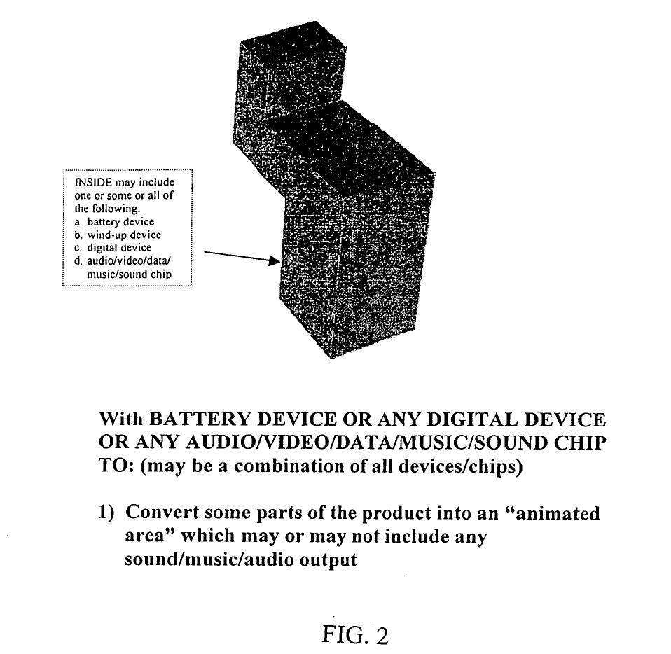

Referring to FIG. 2, the present invention is shown in similar form to FIG. 1, but without the digital screen, control knobs, and audio speaker.

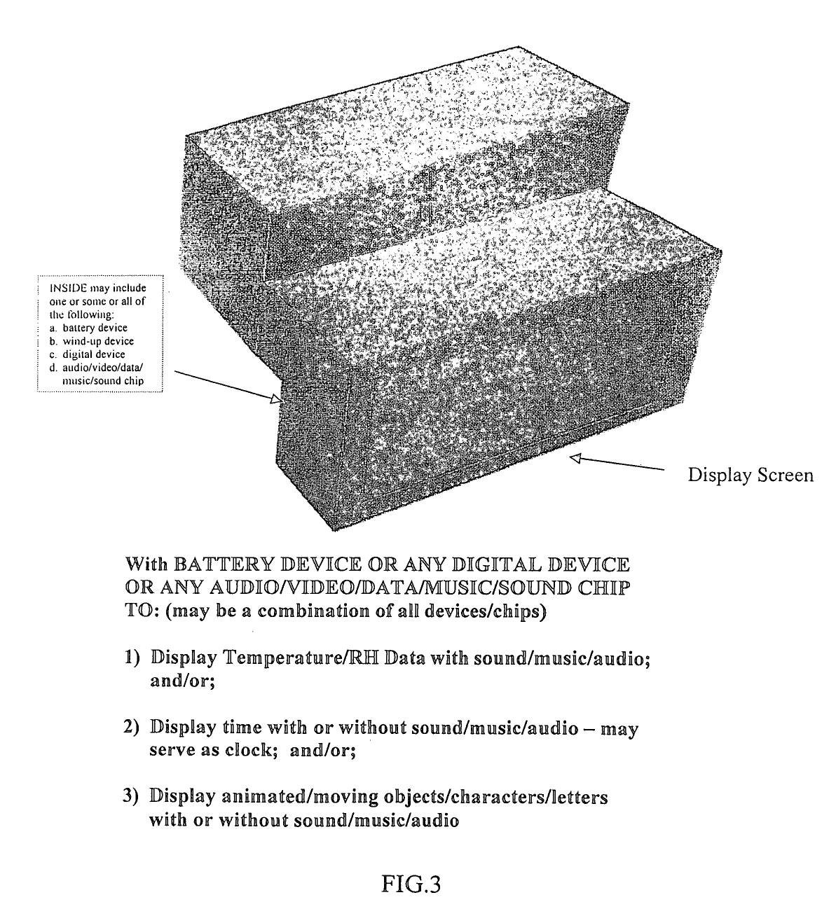

FIG. 3 illustrates the present invention in a second embodiment wherein the base is double in length, but otherwise having similar components as illustrated in FIG. 1. The length of the base is not determinate, but if the present invention is attached on a movable cabinet or refrigerator door, the width is limited by the width of the movable door such that the closing door movement is not inhibited by the base.

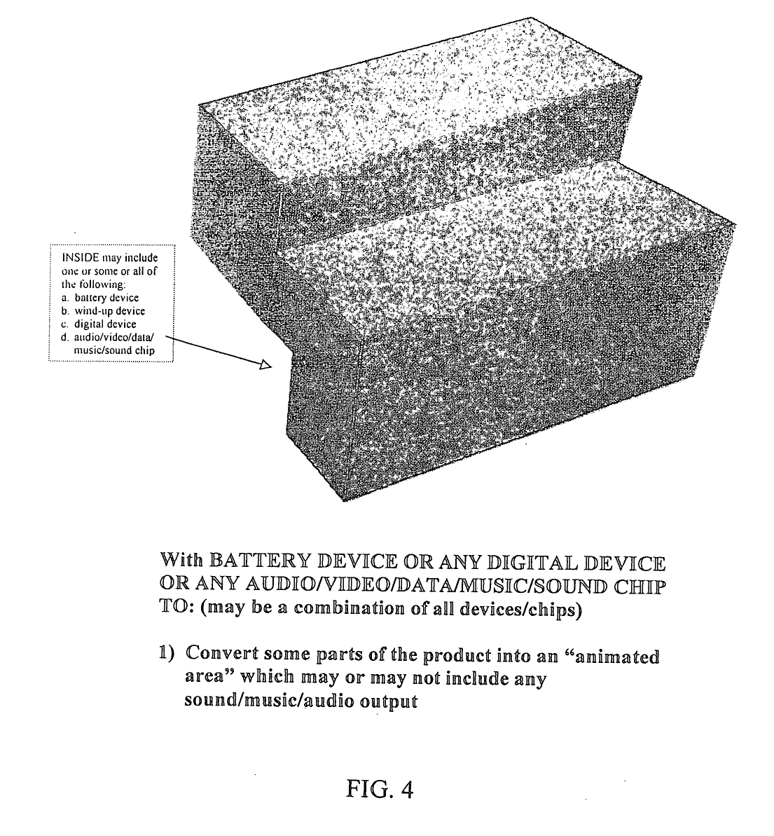

In FIG. 4, the second embodiment of the present invention is shown without a digital screen, but otherwise with the same components as illustrated in FIG. 3.

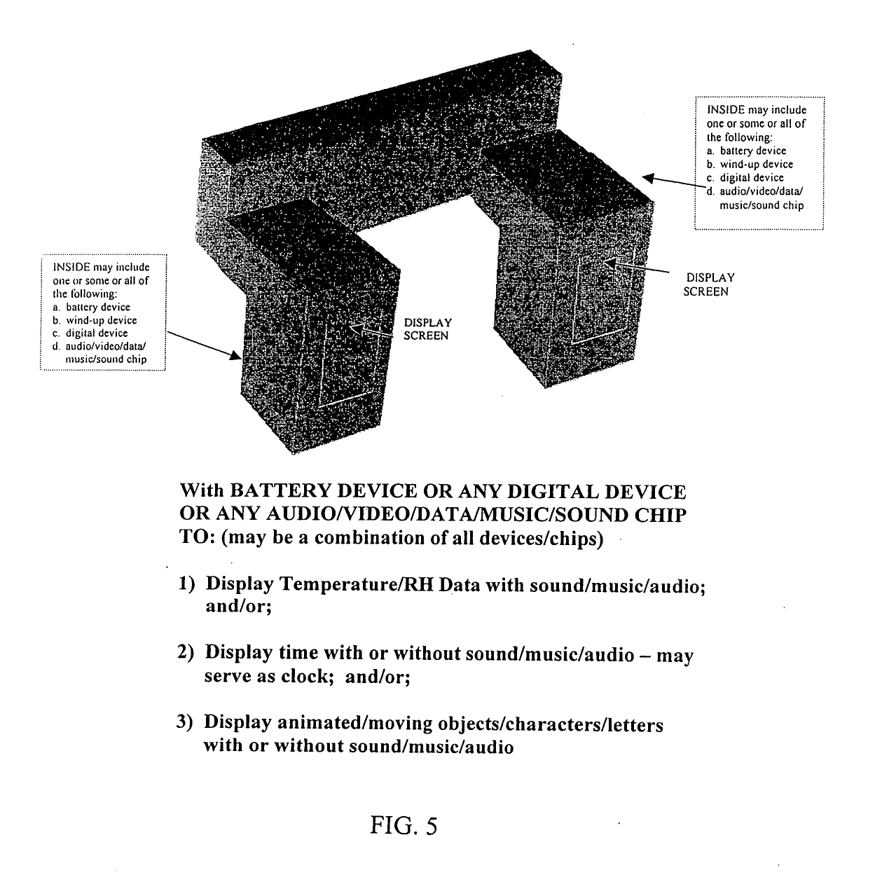

Referring to FIG. 5, a third embodiment of the present invention is illustrated wherein two bases as shown in FIG. 1 are connected by means of a bridge unit 40. Said bridge unit allows for larger decorative, ornamental, and data display devices to be extended across the upper surface of the bridge unit, while the base and vertical downward projections remain spaced apart. This arrangement lessens the cost of the device while adding the additional weight of the bridge unit to the device, reducing in further the likelihood of slippage or separation of the device from the magnet-attracting metal. The vertical downward projections can display the same or different decorative, ornamental, or data devices on either side.

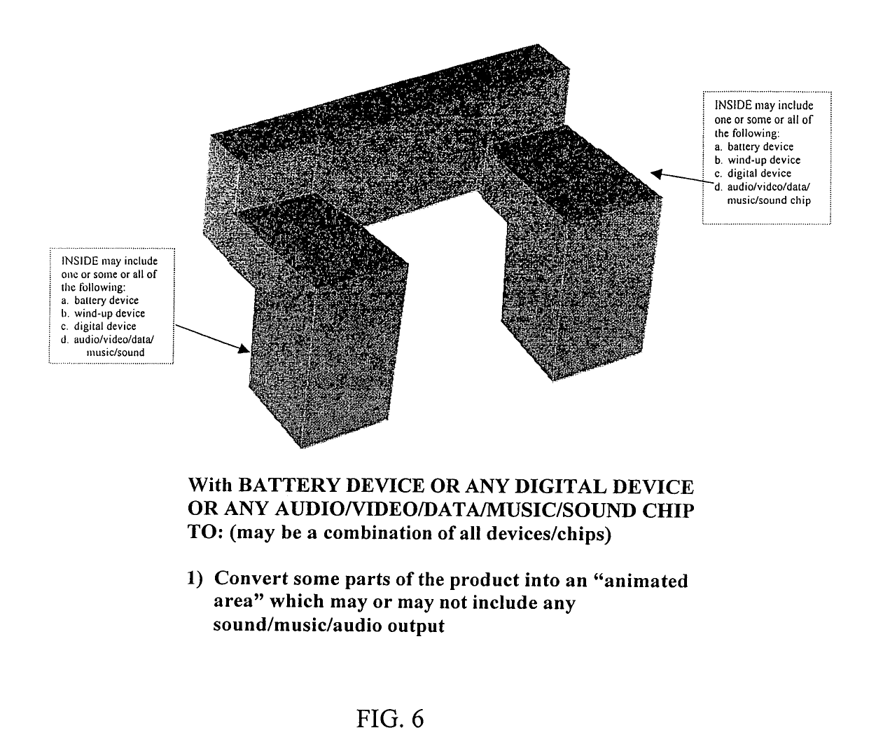

FIG. 6 illustrates the third embodiment of the present invention as described in FIG. 5, but without any data devices shown in the vertical downward projections.

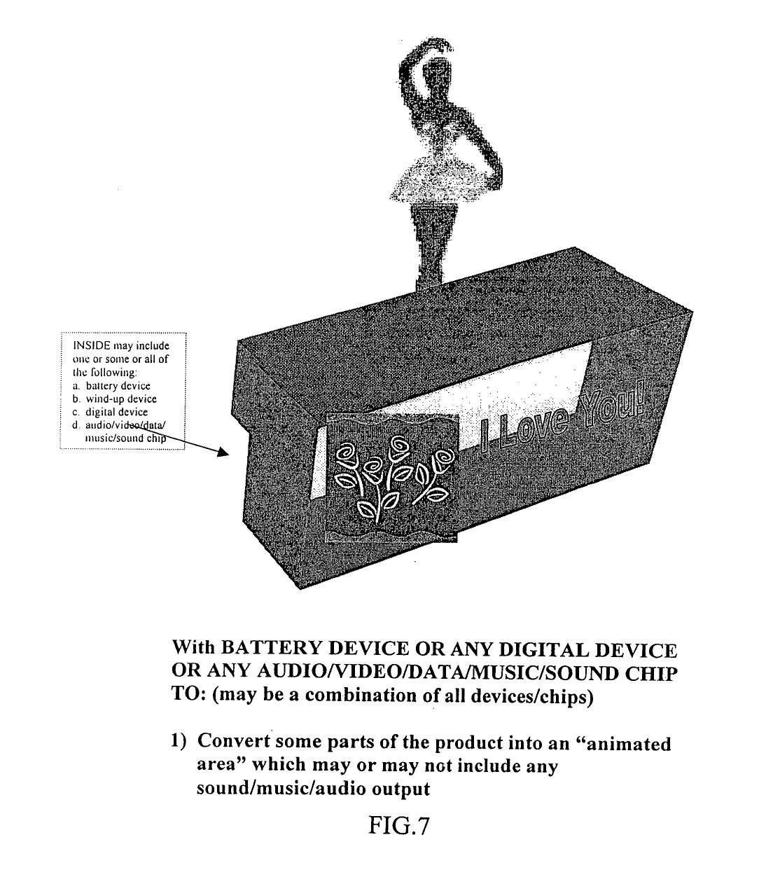

Yet another embodiment of the present invention is shown in FIG. 7, wherein the base 12 is shown with only a downward projection 17, the upward projection having been eliminated. In this Figure, a decoration in the form of a ballerina 50 is illustrated as being attached to the upper surface of the base, said ballerina being optionally connected with a winding device contained inside the base for purposes of rotation of the figurine. The vertical downward projection is shown with a data screen 20 displaying a phrase that can be chosen by the user of the invention and with an ornamental plaque 26.

Referring to FIG. 8A, the first embodiment of the present invention as described in FIGS. 1 and 2 is shown with views of the magnets that are attached to the underside of the device. One magnet 60 is attached to the horizontal base, by which the device attaches to the upper surface of the shelf, cabinet, or refrigerator where the device is placed. The other magnet 64 is attached to the vertical downward projection, by which the device attaches to the front surface of the shelf, cabinet, or refrigerator where the device is placed. The placement of these magnets is shown further in FIGS. 8B and 8C. FIG. 8B is a view of the present invention from straight on its backside. From this view, the magnet 64 attached to the vertical downward projection 17 is visible in its width and length, while the magnet 60 attached to the horizontal base 12 is visible only in its depth. FIG. 8C is a view of the present invention from the bottom. From this view, the magnet 60 attached to the horizontal base 12 is visible in its width and length, while the magnet 64 attached to the vertical downward projection 17 is visible only in its depth.

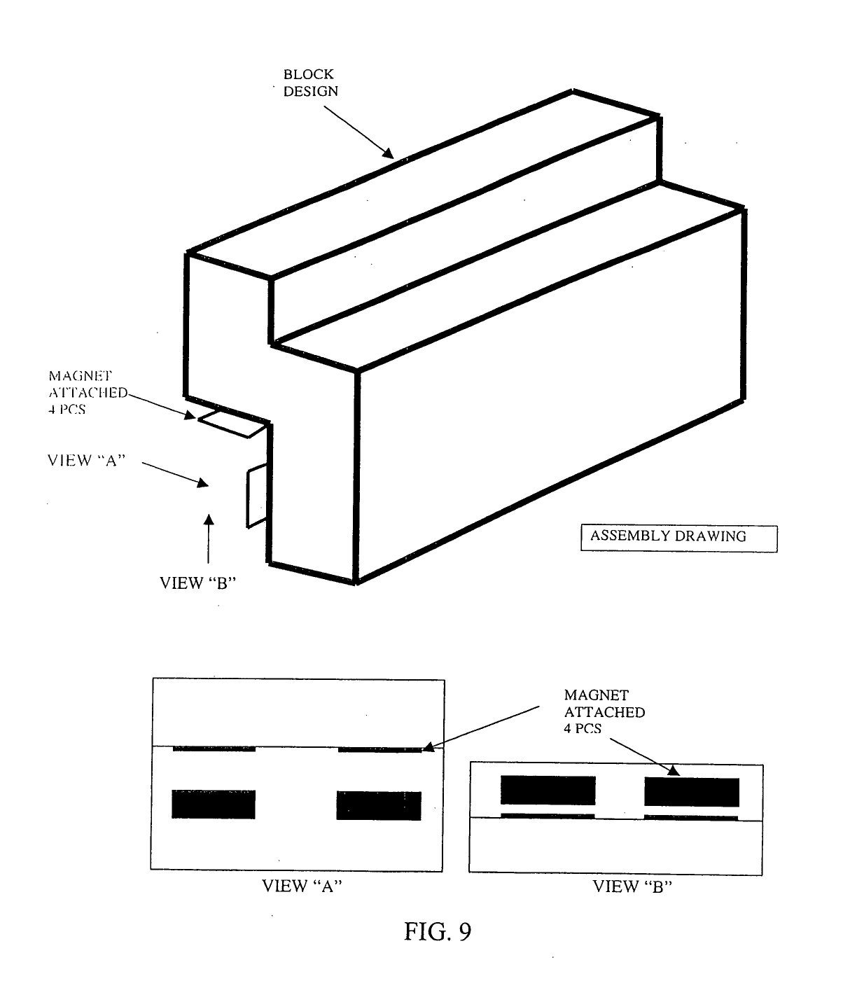

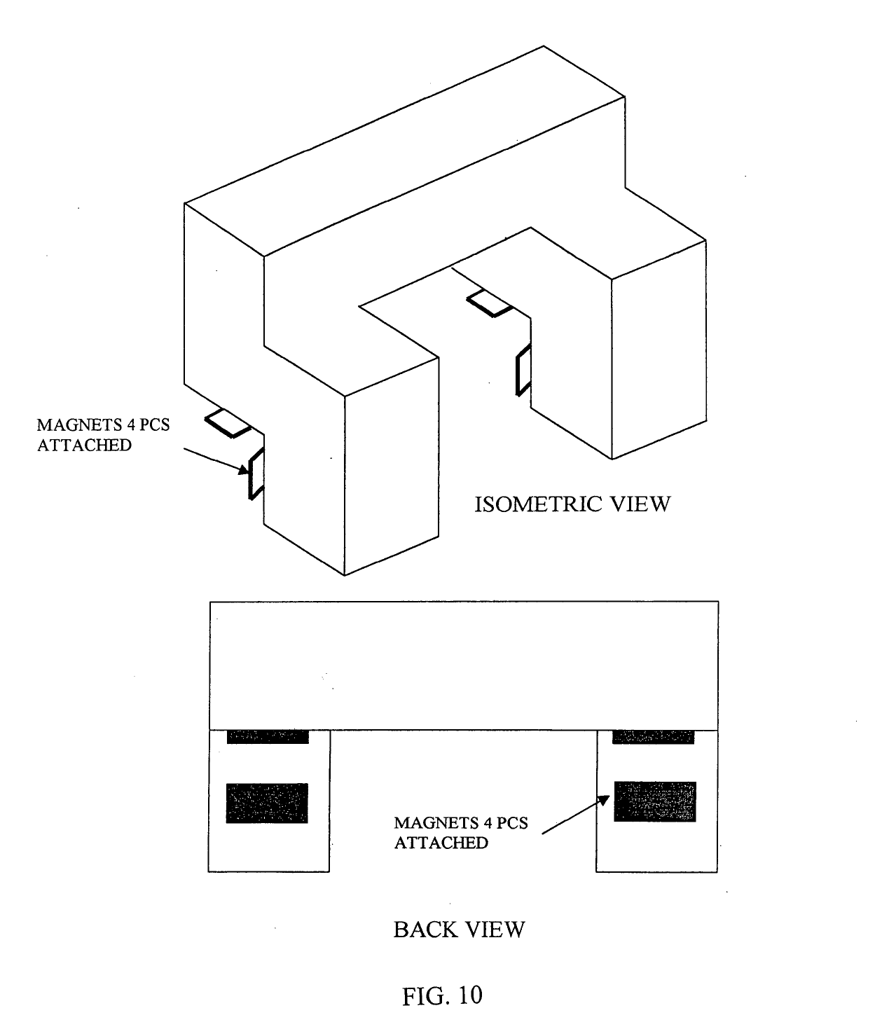

FIGS. 9 and 10 illustrate the second and third embodiment of the present invention from the same views as are demonstrated in FIG. 8 for the first embodiment. The purpose of these figures is to show the magnet placement for each of the embodiments.

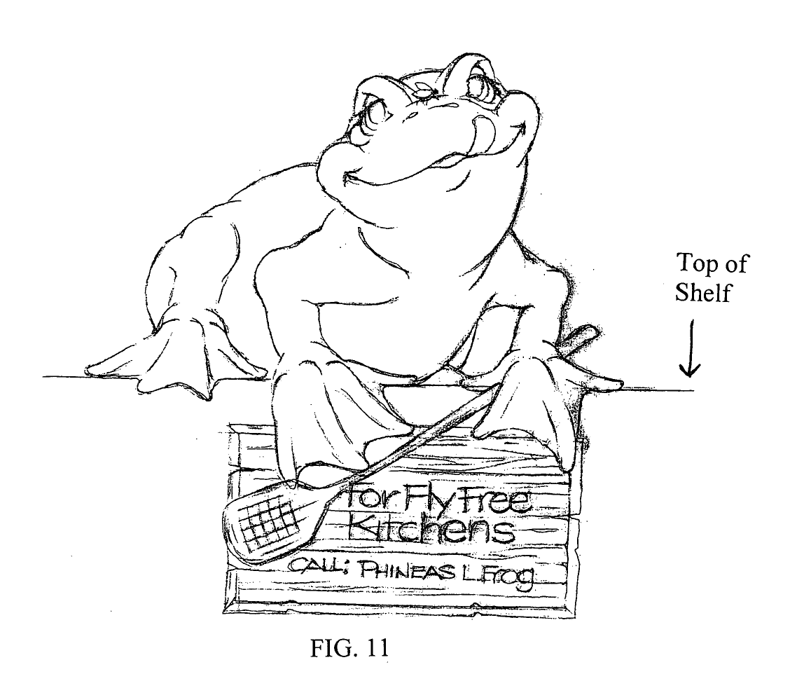

It is considered to be within the scope of this invention that the figure or ornamentation on the magnetic display device could be constructed in any desired representation and that any of a plurality of the functional components could be inserted into said device. Examples of such ornamentation are shown in FIGS. 11 through 17.

FIG. 11 is a view of an advertising display for the present invention. This might, for instance, be used in a display window of a restaurant. The display could be changed at regular intervals to increase interest.

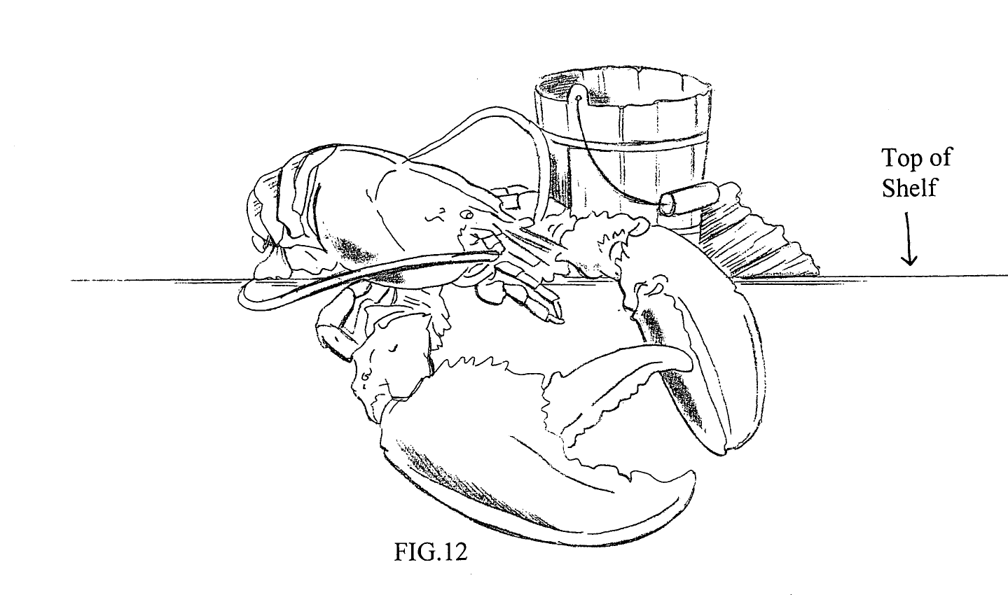

FIG. 12 is a view of a seafood display for the present invention. This again may be used to display in a restaurant, or perhaps in a seafood market.

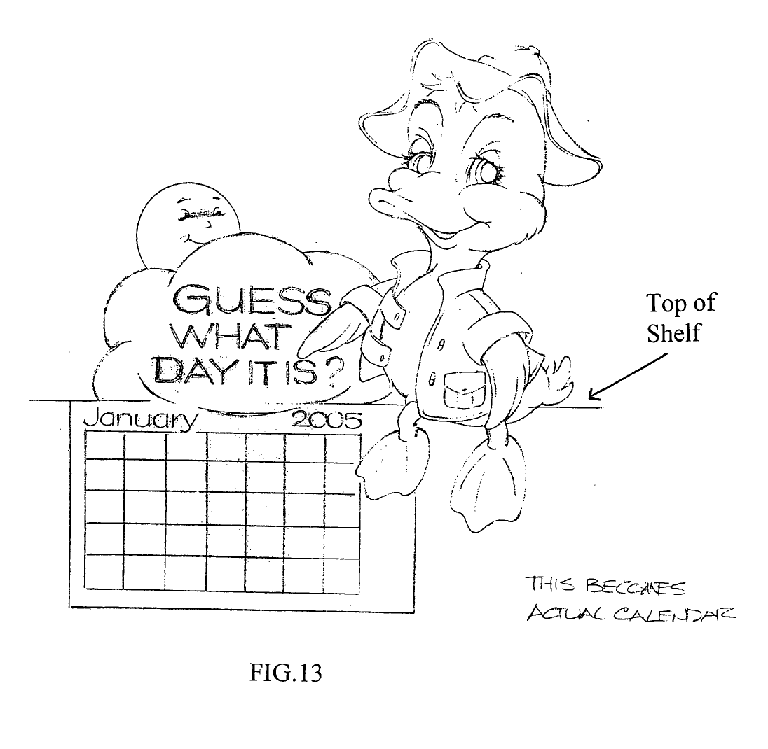

FIG. 13 is a view of a calendar display for the present invention. The display is optionally capable of being a writing surface. In this embodiment, the display becomes a personal calendar of activities for the day, week, or month.

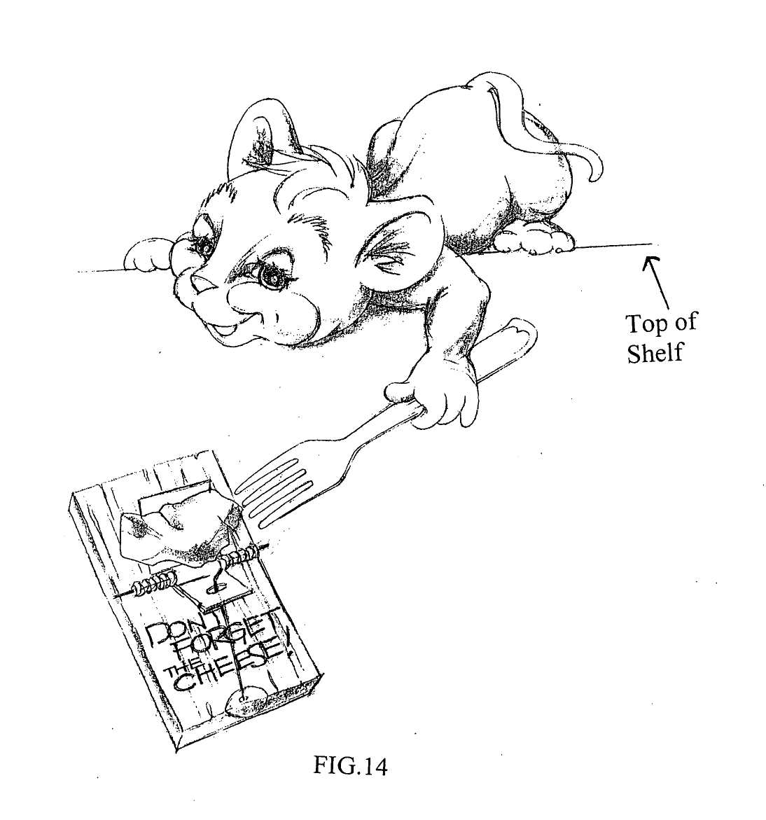

FIG. 14 is a view of a reminder display for the present invention. This might be used as a self reminder, or to communicate messages to others in the family.

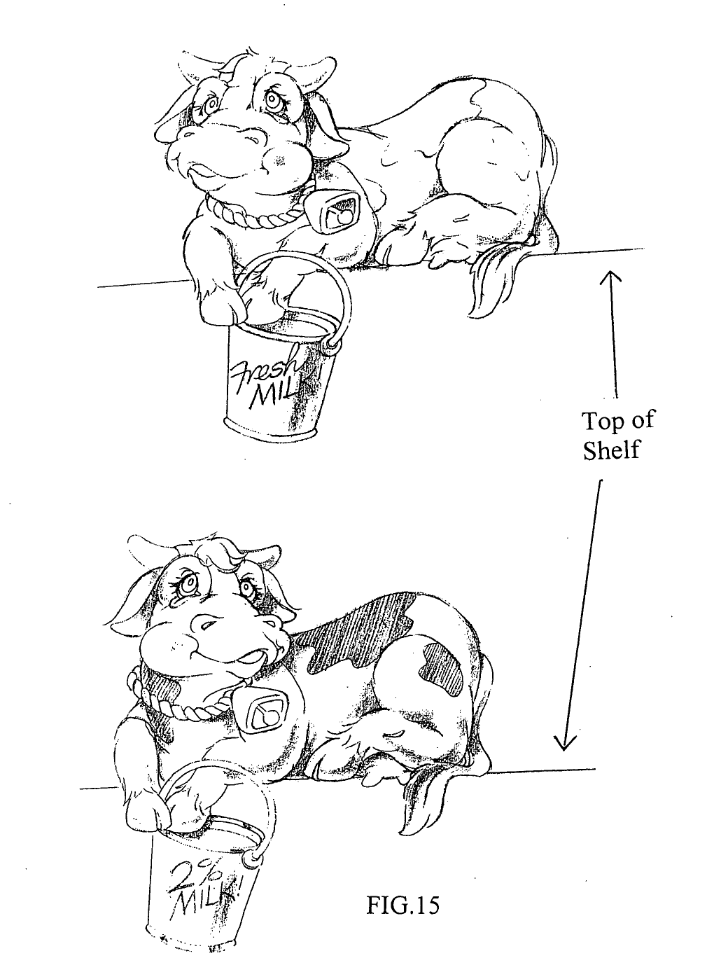

FIG. 15 is a view of another reminder display for the present invention. Alternatively, this could be an advertising display.

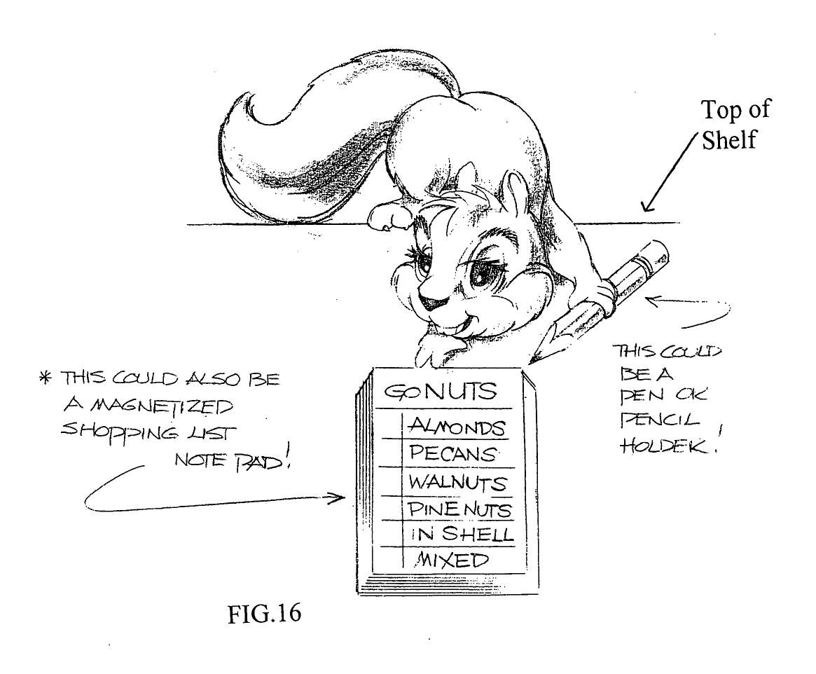

FIG. 16 is a view of a shopping list display for the present invention. As an added embodiment, the shopping list could contain a note pad with detachable pages. The pages could be used for shopping lists, while the display remains mounted at home.

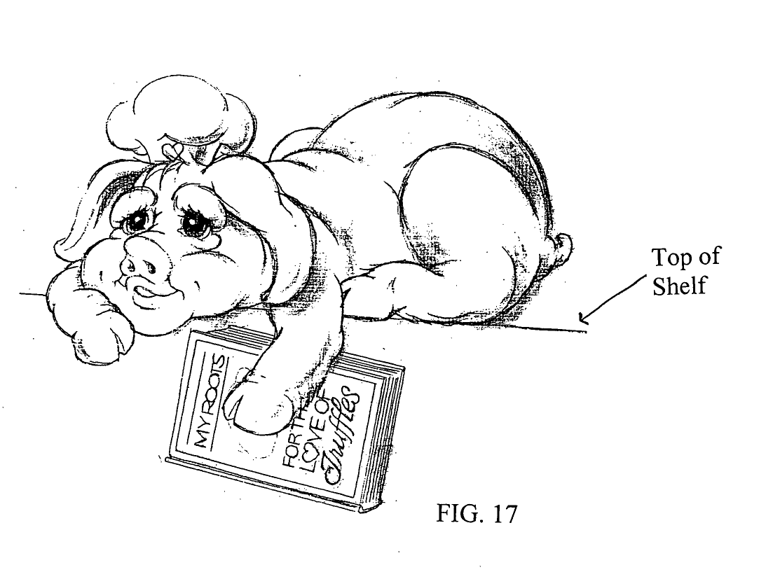

FIG. 17 is a view of a book display for the present invention. This could be a reminder to return borrowed library books, or visit a bookstore.

While the invention has been described in connection with a preferred embodiment or embodiments, it is not intended to limit the scope of the invention to the particular form set forth, but on the contrary, it is intended to cover such alternatives, modifications, and equivalents as may be included within the spirit and scope of the invention as defined by the appended claims.

I claim:

1. A magnetic display unit, comprised of:
a base, said base being substantially planar, rigid, and weighted, having a flat under surface and an upper surface, said under surface having a flat magnet fixedly attached thereto;
said base being integrally attached to at least one arm that extends vertically downward from the front of the base at a 90-degree angle, said downward arm having a flat under surface and an outer surface;
said under surface of said downward arm having a flat magnet fixedly attached thereto; wherein,
said outer vertical surface of said downward arm has attachment means to hold flat articles for display.

2. The display base claimed in claim 1, wherein said attachment means on said downward arm comprise a flat magnet.

3. The display base claimed in claim 1, wherein one of a plurality of ornamental components is affixed to the upper surface of the base.

4. The display base claimed in claim 1, wherein one of a plurality of data display components is affixed to the upper surface of the base.

5. The display base claimed in claim 1, wherein one of a plurality of ornamental components is affixed to the outer surface of the projection.

6. The display base claimed in claim 1, wherein one of a plurality of data display components is affixed to the outer surface of the projection.

7. The display base claimed in claim 1, wherein a projection extends upward from the rear of the base at a 90-degree angle, said projection being capable of having ornamental or data display components affixed to its upper surface.

8. The display base claimed in claim 1, wherein one of a plurality of ornamental components can be changeably affixed to the base.

9. The display base claimed in claim 1, wherein one of a plurality of data display components can be changeably affixed to the base.

10. The display base claimed in claim 3, wherein the data display components consist of digital or battery operated components for the presentation of time, temperature, or animated characters or figures.

11. The display base claimed in claim 3, wherein the data display components consist of digital or battery operated components that are changeable or programmable by the user.

12. The display base claimed in claim 1, wherein two said display bases are connected integrally together by means of a bridge unit.
